(19) United States
(12) Patent Application Publication
(10) Pub. No.: US 2003/0051089 A1
(43) Pub. Date: Mar. 13, 2003

(54) Adapter for communication cards

(75) Inventors: Wen-Tsung Liu, Hsin Tien City (TW); Chia-Li Chen, Hsin Tien City (TW); Mi-Chang Chen, Hsin Tien City (TW)

Correspondence Address: BACON & THOMAS, PLLC, 625 SLATERS LANE, FOURTH FLOOR, ALEXANDRIA, VA, 22314

(73) Assignee: Carry Computer Eng. Co., Ltd.

(21) Appl. No.: 10/170,564

(22) Filed: Jun. 14, 2002

(30) Foreign Application Priority Data
Sep. 10, 2001 (CN) 90215548

(51) Int. Cl. G06F 13/00

(52) U.S. Cl. 710/301

(57) ABSTRACT

The adapter for communication cards especially suits small portable digital devices with operating systems and serial interfaces, these devices can do network data transmission and communication works through communication systems. The adapter is provided on the main body thereof with a transmission unit, a base and at least an insertion slot. Wherein, the base can receive thereon a small portable digital device, a first set of interface pins of the specification same as that of the serial interface of the digital device are provided on the base at a position corresponding to that of the serial interface. The insertion slot is provided for insertion of a communication card, a second set of interface pins are provided therein for connecting with the card. When the first set and the second set of interface pins are connected respectively with the digital device and the card, the digital device can do the works of transmission and communication of network data through the communication card by signal changing of the transmission unit.

### BACKGROUND OF THE INVENTION

1. Field of the Invention

The present invention is related to an adapter for communication cards, and especially to such an adapter suiting personal digital assistants (PDA's), electronic books (e-books), pocket PC's etc. that are small portable digital devices provided with operating systems and serial interfaces, these digital devices can do network data transmission and communication through communication systems.

2. Description of the Prior Art

Since development of the technology of communication and Internet, people have had more and more requirements in communication and processing of information. And under the violent commercial competition environment nowadays, professionals of various businesses are forced to stay in the circumstances of working out of the offices; however, a large amount of information is required by them to back up their actions and decisions. Such strong requirements directly or indirectly give an impetus to the following two markets which develop fast:

1. portable digital devices: for example, personal digital assistants (PDA's), electronic books (e-books), pocket PC's etc.;

2. mobile network access devices: for example, data cards, wireless data cards, network cards and wireless network cards etc.

The abovementioned several portable digital devices can provide respectively for different customers, they are common in two features although they are different in functions. Namely, each of them has an operating system for operating and data processing (such as Plam, WinCE), and a serial interface for data transmission (such as RS232, RS422, RS485) for the purpose that the portable digital devices can not only be carried on people's persons, but also can do two way transmission of data with their personal computers.

The abovementioned mobile network access devices (called for short as communication cards) are developed from the specifications of the portable digital devices originally; as to the specifications, they include PC cards (PCMCIA cards) and CF cards (CompactFlash cards), and are normally used for notebooks to render these communication cards to expand their function in connecting Internet.

The two newly developed industries of portable digital devices and communication cards are fast developed surely in pursuance of developing of the technology of communication and Internet, however, it is pity that these two kinds of industries have not been effectively integrated yet in use, it is mainly because of the limitation of specification. For example, personal digital assistants (PDA's) among portable digital devices are unable to use the communication cards meeting the specifications of PC cards and CF cards.

Therefore, the inventor of the present invention studied the problem of knowing how to render the portable digital devices to combine the advantages of the functions “dataprocessing” as well as “mobile network connection”, in order that a user can surely enjoy the convenient network connection and data processing at any time and any place to thereby meet various requirements in communication and processing of data. And this is the main object of the present invention.

### SUMMARY OF THE INVENTION

Particularly, the adapter for communication cards of the present invention is provided on the main body thereof with a transmission unit, a base and at least an insertion slot. Wherein, the base can receive thereon a small portable digital device, a first set of interface pins of the specification identical to that of the serial interface of the portable digital device are provided on the base at a position in correspondence with that of the serial interface.

The insertion slot is provided for insertion of a communication card, a second set of interface pins are provided therein for connecting with the communication card. When the first set of interface pins and the second set of interface pins are connected respectively with the digital device and the communication card, the digital device can do the works of transmission and communication of network data through the communication card by signal changing of the transmission unit. The improvement of functions of the present invention can be stated below in three aspects:

1. For customers, the present invention can help them to improve the communication connection of every personal portable digital tool with a standard serial interface, to further improve the data access ability of the mobile networks of the customers. Additionally, the customers can make mating of the most suitable data/network application products in pursuance of practical situations of use to do data transmission as well as personal communication.

2. For the manufacturers of personal digital devices, in the past time, the techniques of communication developed very fast, relatively, the corresponding communication products have very short periods of lives, so that the manufacturers have the problems in affording high costs in developing various communication systems. Additionally, the present invention can make them obtain improvement and lowering of cost of studying, the present invention can also satisfy the requirements of customers in using the data access functions of the mobile networks, and make the personal digital devices increase an highly added value, so that they can more meet the requirements of customers and the tendency of markets.

3. As to the manufacturers of communication cards, in the past time, there is no integrating system to integrate some communication cards at a device terminal for the convenience of using of customers; and general personal digital products also are lack of media to connect the cards, this renders the products to be deficient in expansion in the markets. Now, by providing the adapter for communication cards of the present invention, these disadvantageous factors can be eliminated, and the communication cards can get the object of combining with the personal digital products to expand the scope of the markets and to develop new interests of the markets.

The present invention will be apparent in its technical contents as well as features after reading the detailed description of the preferred example thereof in reference to the accompanying drawings.

### BRIEF DESCRIPTION OF THE DRAWINGS

FIG. 1 is an analytic perspective view of the adapter of the present invention;

FIG. 2 is a schematic perspective view from the other side of the present invention;

FIG. 3 is a schematic perspective view showing use of the present invention;

FIG. 4 is another schematic perspective view showing use of the present invention.

### DETAILED DESCRIPTION OF THE PREFERRED EMBODIMENT

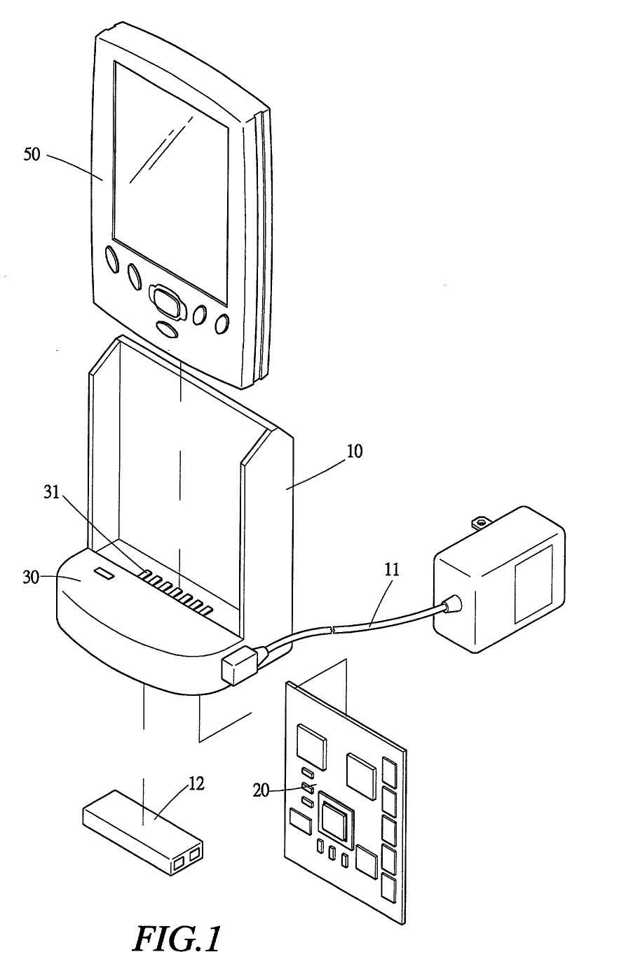

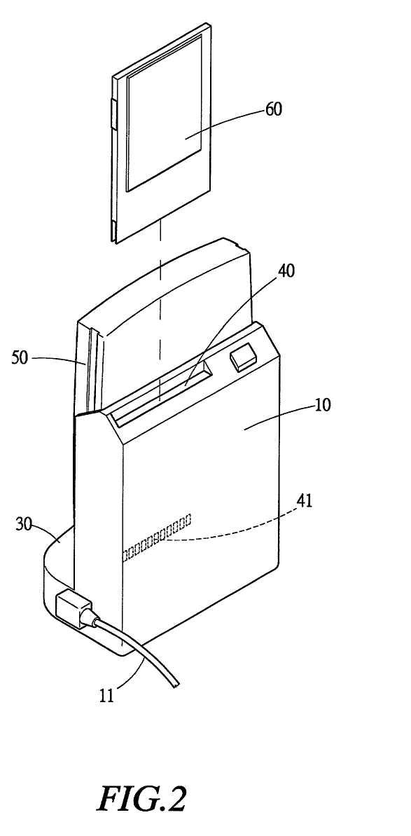

Referring to FIGS. 1 and 2, the adapter for communication cards of the present invention is provided on the main body 10 thereof with a transmission unit 20, a base 30 and at least an insertion slot 40. Wherein, the base 30 can receive thereon a digital device 50 and a communication card 60; thereby the digital device 50 can do the works of transmission and communication of network data through the communication card 60.

Wherein, the main body 10 is provided on the front and the rear ends thereof respectively with the base 30 and the insertion slot 40, and is provided therein with the transmission unit 20 and a power supply unit; the power supply unit includes a power line 11 and a storage battery 12 for providing the power required for operating the transmission unit 20, and for charging the digital device 50.

The transmission unit 20 is an electric circuit board, and is provided therein with the electronic elements including a transmission interface, a chip, a memory and pins etc., these elements are connected between the base 30 and the insertion slot 40 to render the data and signals between the base 30 and the insertion slot 40 to make two way transmission.

The base 30 is generally in the form of a cassette in corresponding to the shape of various small portable digital devices, it can receive a small portable digital device 50, and is provided on a suitable position with a first set of interface pins 31 of the specification identical to that of the serial interface of the digital device 50, the first set of interface pins 31 is connected with the transmission unit 20; when the digital device 50 is placed on the base 30, the first set of interface pins 31 is connected with the serial interface of the digital device 50, so that the digital device 50 can do the works of transmission of data and signals with the transmission unit 20.

The insertion slot 40 (as shown in FIG. 2) is in the shape coincident with that of the slot for the communication card 60, and can receive the communication card 60; it is provided therein with a second set of interface pins 41 also connecting with the transmission unit 20. When the communication card 60 is placed in the insertion slot 40, the second set of interface pins 41 can be connected with the communication card 60, so that the communication card 60 can do the works of transmission of data and signals with the transmission unit 20. Additionally, when in practicing, the insertion slot 40 can be provided on the entrance thereof with a dust-proof lid, and can be provided on the lateral side thereof with a push button for ejecting the communication card 60 by pressing the push button.

The digital device 50 shall be provided with an operating system for operating and data processing (such as Plam, WinCE), and a serial interface for data transmission (such as RS232, RS422, RS485, not shown); the qualified products available in the markets presently at least include: adapter suiting personal digital assistants (PDA's), electronic books (e-books), pocket PC's.

The communication card 60 at least can be a data card, a wireless data card, a network card or a wireless network card etc. for connecting Internet; the specification of the interface thereof at least can be a PC card (PCMCIA card) or a CF card (CompactFlash card).

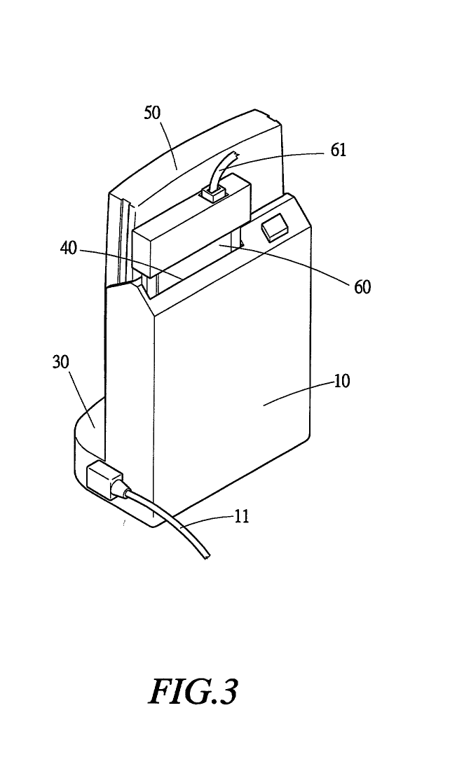

With the above stated structure, when the digital device 50 and the communication card 60 are respectively placed on the base 30 and in the insertion slot 40 of the adapter for communication cards of the present invention (referring to FIGS. 1 and 3), the serial interface of the digital device 50 can be connected with the first set of interface pins 31, so that the transmission unit 20 can read the command or data of the digital device 50, and the second set of interface pins 41 of the insertion slot 40 (referring to FIGS. 2 and 3) can read the data of the communication card 60; and by connection of the transmission unit 20, the digital device 50 and the communication card 60 can do two way transmission of data and signals. Thereby, the digital device 50 can obtain the above stated effect in combining the functions of “data processing” as well as of “mobile network connection”.

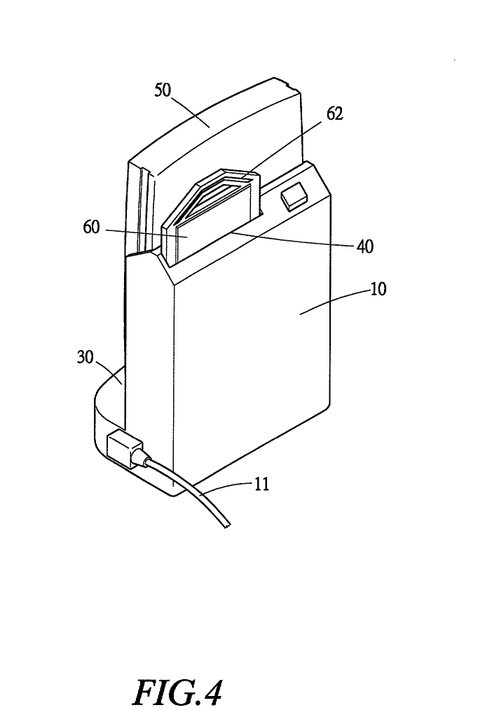

FIGS. 3 and 4 disclose the practical state of use of the communication card 60; the communication card 60 at least can be a data card, a wireless data card, a network card or a wireless network card etc. Wherein, the data card (FIG. 3) is provided on the tailing end thereof with a telephone line socket to afford insertion connecting of a telephone line terminal 61. The digital device 50 is provided at the rear of the base 30, and can make commands for the communication card 60 (data card) taking advantage of application software (such as an browser), and can do receiving and emitting of E-mails, networking for browsing, downloading data etc. through the telephone line terminal 61 connecting externally of the communication card 60. Similarly, if the communication card 60 is a wireless network card (FIG. 4), and is provided thereon with a communication antenna 62, it can be similarly connected with Internet to do various communication application works.

The names of the elements composing the present invention are only for illustrating the technique content of a preferred embodiment of the present invention, and not for giving any limitation to the scope of the present invention. It will be apparent to those skilled in this art that various equivalent modifications without departing from the spirit of this invention shall fall within the scope of the appended claims.

1. An adapter for communication cards, said adapter is provided on the main body thereof with a transmission unit, a base and at least an insertion slot; wherein, said base receives thereon a portable digital device, a first set of interface pins of the specification identical to that of a serial interface of said portable digital device are provided on said base at a position in correspondence with that of said serial interface; said insertion slot is provided for insertion of a communication card, a second set of interface pins are provided therein for connecting with said communication card; when said first set of interface pins and said second set of interface pins are connected respectively with said digital device and said communication card to separately transmit data and signals with said transmission unit, by signal changing and transmission of said transmission unit, said digital device does the works of transmission and communication of network data through said communication card.

2. The adapter for communication cards as in claim 1, wherein
said main body is provided therein with a power supply unit, said power supply unit includes a power line and a storage battery for providing the power required for operation of said transmission unit and for charging said digital device.

3. The adapter for communication cards as in claim 1, wherein
said insertion slot is provided on the entrance thereof with a dust-proof lid, and can be provided on the lateral side thereof with a push button.

4. The adapter for communication cards as in claim 1, wherein
said digital device is provided with an operating system for operating and data processing, and with a serial interface for data transmission.

5. The adapter for communication cards as in claim 1, wherein
said digital device is one of at least a personal digital assistant, an electronic book and a pocket PC.

6. The adapter for communication cards as in claim 1, wherein
said communication card is one of at least a data card, a wireless data card, a network card and a wireless network card.

7. The adapter for communication cards as in claim 1, wherein
said communication card has an interface of which the specification is one of at least a PC card and a CF card.
